(19) United States
(12) Patent Application Publication
(10) Pub. No.: US 2013/0097886 A1
(43) Pub. Date: Apr. 25, 2013

(54) METHOD OF DRYING WATER-BASED RUBBER MIXES FOR PRODUCING TYRES

(71) Applicant: Alessandro Basile, Albano Laziale (IT)

(72) Inventor: Alessandro Basile, Albano Laziale (IT)

(73) Assignee: BRIDGESTONE CORPORATION, Chuo-Ku, Tokyo (JP)

(21) Appl. No.: 13/583,158

(22) PCT Filed: Mar. 16, 2011
(86) PCT No.: PCT/IB11/00559

§ 371 Date: Dec. 18, 2012

(30) Foreign Application Priority Data
Mar. 16, 2010 (IT) TO2010A000202

(51) Int. Cl. F26B 3/347

(52) U.S. Cl. CPC F26B 3/347
USPC 34/266

(57) ABSTRACT

A method of drying a water-based rubber mix for producing tyres, wherein the water-based rubber mix is treated with infrared radiation for a time period of over 60 seconds and of 100 seconds or less. The infrared radiation is produced by a filament at a temperature of 500 to 850° C., and positioned at a distance of 5 to 10 cm from the water-based rubber mix for drying.

### TECHNICAL FIELD

The present invention relates to a method of drying water-based rubber mixes for producing tyres.

### BACKGROUND ART

Water-based rubber mixes are becoming increasingly popular in the tyre industry as a valid alternative to conventional solvent-based mixes, use of which has been drastically reduced by recent European directives for ecological reasons.

In the tyre industry, in addition to making tyre component parts, rubber mixes are also used for other purposes, such as bonding parts together, repairs, or decorative work, in which the rubber mix is spread on.

A good example of this are cements, which are widely used in tyre manufacturing, retreading and repairs.

Cements are typically used for repairing so-called AGR agricultural vehicle tyres, which substantially involves first removing the damaged part; cleaning the exposed part with solvent; and applying new green rubber with the interposition of a layer of cement.

Cements are also used for cold retreading tyres, in which case, the worn tread is removed from the tyre; and the casing, which is still in good working condition, is fitted with a new pre-cured tread. Uncured cement is interposed between the cleaned casing and the new tread, to ensure adhesion of the new tread to the casing when the tyre is cold cured.

Another spread-on mix application is the decoration or repair of tyres using polymer paints.

Substituting water-based for solvent-based rubber mixes obviously involves a drying stage to remove the water from the mix. This is not necessary when working with solvent-based rubber mixes, on account of the highly volatile nature of the solvents used, which evaporate with no need for any particular technical procedures.

When performed using conventional methods, such as hot-air circulation in an oven, the drying stage poses various problems, foremost of which are the time involved, and the formation of a microfilm of water under a ‘dry’ surface layer.

### DISCLOSURE OF INVENTION

It is an object of the present invention to provide a method of drying water-based rubber mixes, designed to ensure fast, effective drying.

According to the present invention, there is provided a method of drying a water-based rubber mix for producing tyres; said method being characterized by treating said water-based rubber mix with infrared radiation for a time period of over 60 seconds and of 100 seconds or less; said infrared radiation being produced by a filament at a temperature of 500 to 850° C., and positioned at a distance of 5 to 10 cm from the water-based rubber mix for drying.

In a preferred embodiment of the present invention, the temperature of the filament ranges between 600 and 750° C.

In a preferred embodiment, the infrared radiation has a wavelength of 3000 to 6000 nm.

According to the present invention, there is also provided a tyre repair method, characterized by comprising use of a water-based rubber mix as a repair mix, and subjecting said water-based rubber mix to a drying method in accordance with the present invention.

According to the present invention, there is also provided a method of bonding two tyre components, characterized by comprising use of a water-based rubber mix as cement, and subjecting said water-based rubber mix to a drying method in accordance with the present invention.

According to the present invention, there is also provided a tyre painting method, characterized by comprising use of a water-based rubber mix as a paint mix, and subjecting said water-based rubber mix to a drying method in accordance with the present invention.

### BEST MODE FOR CARRYING OUT THE INVENTION

The following are purely non-limiting examples, for a clearer understanding of the invention.

The examples given relate to laboratory tests, in which a water-based cement, after being applied, was dried using the method according to the present invention and, for comparison purposes, using hot air.

More specifically, the cement was subjected to different infrared radiation wavelengths and for different lengths of time.

Table I shows the weight percentage composition of the cements used.

TABLE I

| | |
|---|---|
| WATER | 50.0 |
| NATURAL RUBBER | 25.6 |
| CARBON BLACK | 13.0 |
| ZINC OXIDE | 1.0 |
| ADHESIVE RESIN | 3.6 |
| SULPHUR | 0.5 |
| SULPHONAMIDE | 0.5 |
| SODIUM-OLEOYLSARCOSINE | 2.5 |

The water-based cement in the examples is in no way limiting, and is simply an example of one of the many water-based mixes to which the method according to the present invention applies. The method according to invention applies to any water-based mix, regardless of its composition, and in fact may also be used to advantage with water-based rubber mixes for other than bonding purposes, such as repair or decoration.

In the examples described, 1.33 g/dm² of cement was applied to the surface of a 30×30 cm precured tread strip commonly used for cold retreading tyres.

Table II shows different drying conditions, and the corresponding results in terms of dryness and surface temperature upon completion of the drying stage.

More specifically, examples A-C refer to the drying method according to the present invention, and to variations in the infrared radiation wavelength and exposure time to radiation; and example D is a control example, in which drying is performed by hot-air circulation in an oven.

TABLE II

| Example | A | B | C | D |
|---|---|---|---|---|
| Airflow speed | == | == | == | 6.5 |
| (m/min) | | | | |
| Filament or oven | 850-950 | 600-750 | 600-750 | 55 |
| temperature (° C.) | | | | |
| Filament power (W) | 2500 | 1670 | 1670 | == |
| Peak wavelength (nm) | 2360 | 3320 | 3320 | == |
| Distance from | 7.5 | 7.5 | 7.5 | == |
| filament (cm) | | | | |
| Precured tread strip | 15 | 15 | 15 | 17 |
| temperature (° C.) | | | | |
| before testing | | | | |
| Exposure time (s) | 60 | 60 | 90 | 420 |
| Dryness evaluation | D | SM | D | D |
| Dried-mix | 75 | 40 | 55 | 40 |
| temperature (° C.) | | | | |

In the dryness evaluation section, ‘D’ stands for ‘dry’, and ‘SM’ for ‘slightly moist’.

Dryness was evaluated visually; by touch, by applying a sheet of blotting paper to the treated mix; and by calculating the difference in weight before and after infrared radiation treatment.

Example C was judged the most successful. In fact, if too much mix is used in the Example A and B conditions, Example A may result in the formation of a microfilm of water under a ‘dry’ surface layer, and Example B in less than thorough drying of the mix. In the Example C conditions, on the other hand, a perfectly dry mix with absolutely no microfilm of water is achieved, even when using large amounts of water-based mix.

The method according to the present invention provides for effectively drying water-based rubber mixes without jeopardizing the operation in which the mix is used. Also, using infrared lamps, the method according to the present invention is extremely practical, even when working on extra-large tyres, as when repairing AGR tyres.

1. A method of drying a water-based rubber mix for producing tyres; said method being characterized by treating said water-based rubber mix with infrared radiation for a time period of over 60 seconds and of 100 seconds or less; said infrared radiation being produced by a filament at a temperature of 500 to 850° C., and positioned at a distance of 5 to 10 cm from the water-based rubber mix for drying.

2. A method of drying a water-based rubber mix, as claimed in claim 1, characterized in that the infrared radiation employed is produced by a filament at a temperature of 600 to 750° C.

3. A method of drying a water-based rubber mix, as claimed in claim 1, characterized in that the infrared radiation employed has a wavelength of 3000 to 6000 nm.

4. A tyre repair method, characterized by comprising use of a water-based rubber mix as a repair mix, and subjecting said water-based rubber mix to a drying method as claimed in claim 1.

5. A method of bonding two tyre components, characterized by comprising use of a water-based rubber mix as cement, and subjecting said water-based rubber mix to a drying method as claimed in claim 1.

6. A tyre painting method, characterized by comprising use of a water-based rubber mix as a paint mix, and subjecting said water-based rubber mix to a drying method as claimed in claim 1.
